(19) United States
(12) Patent Application Publication
(10) Pub. No.: US 2026/0323205 A1
(43) Pub. Date: Oct. 15, 2026

(54) SPEAKER AND ELECTRONIC DEVICE INCLUDING THE SAME

(71) Applicant: SAMSUNG ELECTRONICS CO., LTD., Suwon-si (KR)

(72) Inventors: Hunki LEE, Suwon-si (KR); Janghoon KANG, Suwon-si (KR); Seonmi KIM, Suwon-si (KR); Yeongjun KIM, Suwon-si (KR); Joonrae CHO, Suwon-si (KR)

(21) Appl. No.: 19/691,862

(22) Filed: May 29, 2026

Related U.S. Application Data
(63) Continuation of application No. PCT/KR2024/018387, filed on Nov. 20, 2024.

(30) Foreign Application Priority Data
Dec. 6, 2023 (KR) 10-2023-0175394
Jan. 17, 2024 (KR) 10-2024-0007549

(51) Int. Cl. H04R 1/34; H04R 1/02; H04R 7/02

(52) U.S. Cl. CPC H04R 1/345; H04R 1/025; H04R 1/028; H04R 7/02; H04R 2499/11

(57) ABSTRACT

An electronic device includes a housing, a speaker, a first sound path and a second sound path. The housing may include a first opening or a second opening. The second opening may be oriented in a different direction than the first opening. The speaker may be disposed in the housing. The speaker may include a diaphragm. When the diaphragm vibrates, a first sound output from a first surface of the diaphragm may have substantially the opposite phase as a second sound output from the other surface of the diaphragm.

### CROSS-REFERENCE TO RELATED APPLICATIONS

This application is a continuation application of International Application No. PCT/KR 2024/018387 designating the United States, filed on Nov. 20, 2024, in the Korean Intellectual Property Receiving Office and claiming priority to Korean Patent Application No. 10-2023-0175394 filed Dec. 6, 2023 and to Korean Patent Application No. 10-2024-0007549 filed Jan. 17, 2024 in the Korean Intellectual Property Office, the disclosures of which are incorporated by reference herein in their entireties.

### BACKGROUND

### (1) Field

Various embodiments of the disclosure relate to an electronic device, for example, a speaker, and an electronic device including the same.

### (2) Description of the Related Art

Owing to the remarkable development of information and communication technology and semiconductor technology, the supply and use of various electronic devices are rapidly increasing. Electronic devices are developed so that they are used for communication while being carried.

An electronic device may refer to a device that performs specific functions based on a built-in program, such as a home appliance, an electronic organizer, a portable multimedia player, a mobile communication terminal, a tablet personal computer (PC), a video/audio device, a desktop/laptop computer, or a vehicle navigation device. For example, these electronic devices may output stored information as sound or a video. As electronic devices have become more integrated, and ultra-high-speed and large-capacity wireless communication has become commonplace, a single electronic device, such as a mobile communication terminal, may now be equipped with various functions. For example, not only communication functions but also entertainment functions like gaming, multimedia functions like music/video playback, communication and security functions for mobile banking, and various other functions like schedule management or an electronic wall (e-wallet) are all integrated into a single electronic device. Such electronic devices are miniaturized so that users may carry them conveniently.

The above information is presented as related art only to assist with an understanding of the disclosure. No determination has been made, and no assertion is made, as to whether any of the above might be applicable as prior art with regard to the disclosure.

### SUMMARY

According to an embodiment of the disclosure, an electronic device may include a housing, a speaker, a first sound path, or a second sound path. The housing may include a first opening or a second opening. The second opening may face in a direction different from a direction in which the first opening faces. The speaker may be disposed in the housing. The speaker may include a diaphragm. When the diaphragm is vibrated, a first sound generated by the vibration of the diaphragm may be output through the first sound path extending from a first surface of the diaphragm to the first opening, and a second sound generated by the vibration of the diaphragm may be output through the second sound path extending from another surface of the diaphragm to the second opening. A phase of the first sound may be substantially opposite to a phase of the second sound.

According to an embodiment of the disclosure, an electronic device may include a housing, a speaker, a first sound path, a second sound path, or at least one door. The housing may include a first opening or a second opening. The second opening may face in a direction different from a direction in which the first opening faces. The speaker may be disposed in the housing. The speaker may include a diaphragm. The first sound path may be associated with one side of the diaphragm and the first opening. The second sound path may be associated with the other side of the diaphragm and the second opening. The at least one door may be disposed in the second sound path. The second sound path may be configured to be opened or closed by the at least one door.

According to an embodiment of the disclosure, an electronic device may include a housing, a speaker, a first sound path, a second sound path, or at least one door. The housing may include a first opening or a second opening. The second opening may face a direction different from a direction in which the first opening faces. The speaker may be disposed in the housing. The speaker may include a diaphragm. The first sound path may be associated with one side of the diaphragm and the first opening. The second sound path may be associated with the other side of the diaphragm and the second opening. The at least one door may be disposed in at least one of the first sound path or the second sound path.

According to an embodiment of the disclosure, an electronic device may include a housing, a speaker, a first sound path, a second sound path, at least one door, at least one processor, or memory. The housing may include a first opening or a second opening. The second opening may face a direction different from a direction in which the first opening faces. The speaker may be disposed in the housing. The speaker may include a diaphragm. The first sound path may be associated with one side of the diaphragm and the first opening. The second sound path may be associated with the other side of the diaphragm and the second opening. The at least one door may be disposed in the second sound path. The at least one processor may include processing circuitry. The memory may store at least one instruction. The at least one instruction, when executed individually or collectively by the at least one processor, may cause the electronic device to perform at least one operation. The at least one operation may include identifying an output of the speaker. The at least one operation may include identifying whether the electronic device is in a call mode based on a state in which the speaker is outputting. The at least one operation may include controlling the at least one door such that the second sound path is opened, based on the electronic device being in the call mode.

### BRIEF DESCRIPTION OF THE DRAWINGS

FIG. 1 is a block diagram illustrating an electronic device in a network environment according to various embodiments.

FIG. 2 is a perspective view illustrating a front surface of an electronic device according to an embodiment of the disclosure.

FIG. 3 is a perspective view illustrating a rear surface of an electronic device according to an embodiment of the disclosure.

FIG. 4 is an exploded perspective view illustrating a front surface of an electronic device according to an embodiment of the disclosure.

FIG. 5 is an exploded perspective view illustrating a rear surface of an electronic device according to an embodiment of the disclosure.

FIG. 6A is a cross-sectional view taken along line A-A′ of FIG. 2 according to an embodiment of the disclosure.

FIG. 6B is a cross-sectional view taken along line A-A′ of FIG. 2 according to an embodiment of the disclosure.

FIG. 7 is a flowchart illustrating a method for operating an electronic device according to an embodiment of the disclosure.

FIG. 8 is a cross-sectional view illustrating an electronic device according to an embodiment of the disclosure.

FIG. 9 is a cross-sectional view illustrating an electronic device according to an embodiment of the disclosure.

FIG. 10 is a cross-sectional view illustrating an electronic device according to an embodiment of the disclosure.

FIG. 11 is a cross-sectional view illustrating an electronic device according to an embodiment of the disclosure.

FIG. 12 is a cross-sectional view illustrating an electronic device according to an embodiment of the disclosure.

FIG. 13 is a cross-sectional view illustrating an electronic device according to an embodiment of the disclosure.

FIG. 14 is a cross-sectional view taken along line B-B′ of FIG. 13 according to an embodiment of the disclosure.

FIG. 15 is a cross-sectional view illustrating an electronic device according to an embodiment of the disclosure.

FIG. 16 is a cross-sectional view taken along line C-C′ of FIG. 15 according to an embodiment of the disclosure.

FIG. 17 is a cross-sectional view illustrating an electronic device according to an embodiment of the disclosure.

FIG. 18 is a flowchart illustrating a method for operating an electronic device according to an embodiment of the disclosure.

FIG. 19 is a diagram illustrating a state of making a call through an electronic device according to an embodiment of the disclosure.

FIG. 20 is a graph illustrating the levels of leaked sounds measured in a first state and a second state of an electronic device, respectively according to an embodiment of the disclosure.

### DETAILED DESCRIPTION

With reference to the accompanying drawings, embodiments of the disclosure will be described below in detail so that those skilled in the art may easily implement them. However, the disclosure may be implemented in various different forms and is not limited to the embodiments described herein. In connection with the description of the drawings, the same or similar reference numerals may be used for the same or similar components. In addition, in the drawings and related descriptions, a description of well-known functions and configurations may be avoided for clarity and conciseness.

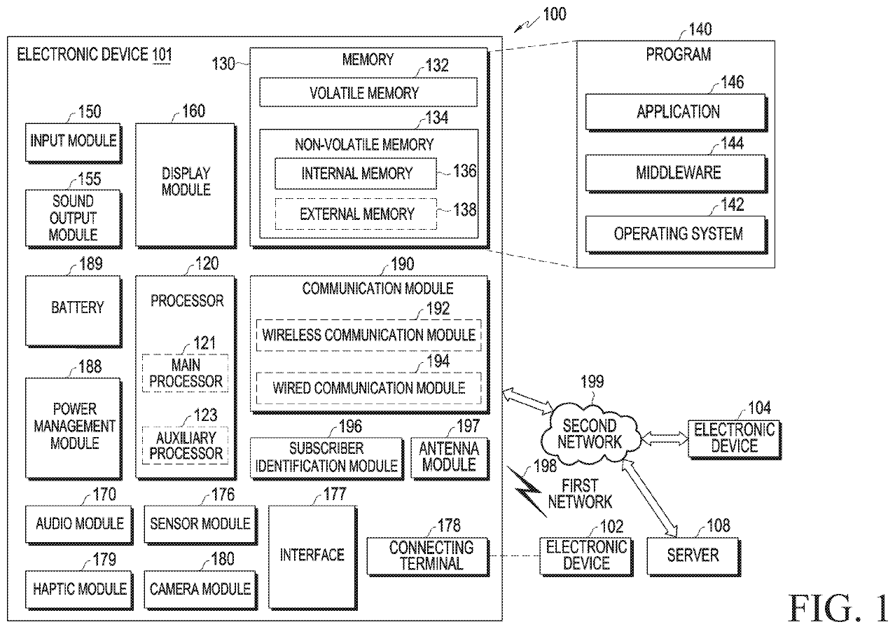

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to some embodiments, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, (2-1)th or (2-2)th, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be understood that when an element is referred to as being related to another element “on” or “connected to” another element, it can be directly on the other element or intervening elements may be present therebetween. In contrast, when an element is referred to as being related to another element such as being “directly on” or “directly connected to” another element, there are no intervening elements present.

As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

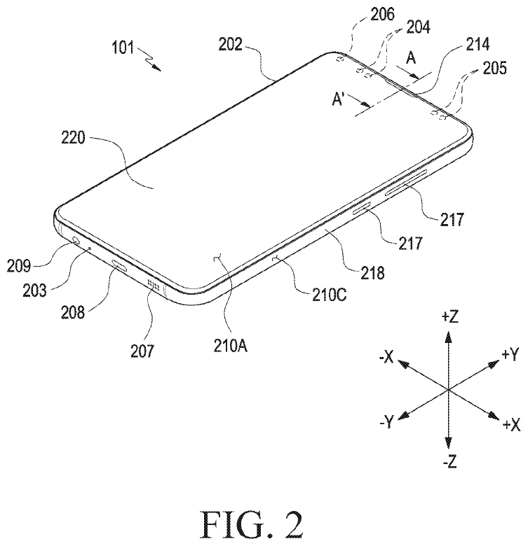

For the convenience of description of FIGS. 2 to 16, FIGS. 2 to 16 illustrate a Cartesian coordinate system defined and interpreted by X, Y, and Z axes that are orthogonal to each other. For the convenience of description, an X-axis direction may be defined and interpreted as a width direction of an electronic device or the components of the electronic device, a Y-axis direction may be defined and interpreted as a length direction of the electronic device or the components of the electronic device, and a Z-axis direction may be defined and interpreted as a height direction (or thickness direction) of the electronic device or the components of the electronic device.

FIG. 2 is a perspective view illustrating a front surface of an electronic device according to an embodiment of the disclosure.

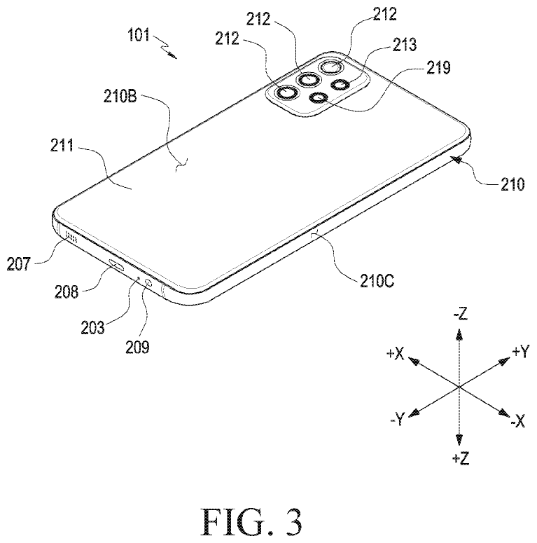

FIG. 3 is a perspective view illustrating a rear surface of an electronic device according to an embodiment of the disclosure.

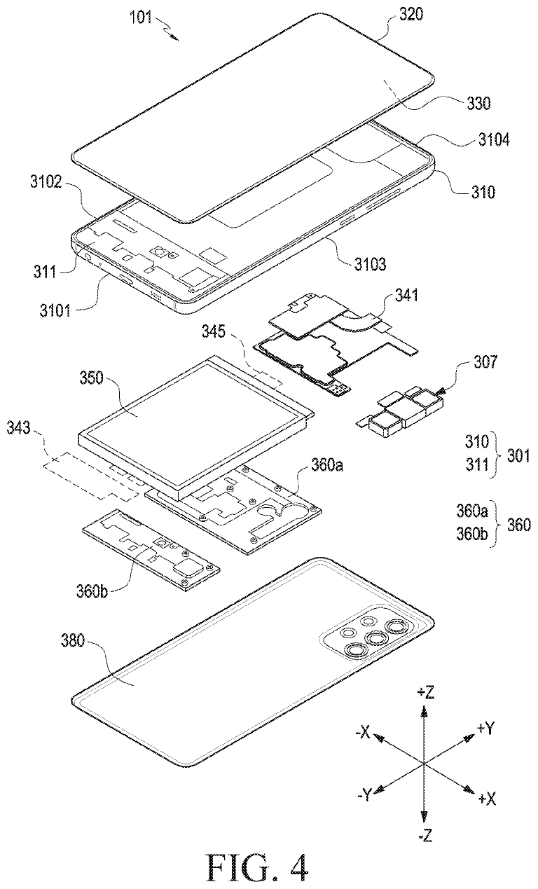

The embodiments of FIGS. 2 and 3 may be combined with the embodiment of FIG. 1 and/or the embodiments of FIGS. 4 to 20.

Referring to FIGS. 2 and 3, the electronic device 101 (e.g., the electronic device 101 in FIG. 1) according to an embodiment may include a housing 210 which includes a first surface (or front surface) 210A, a second surface (or rear surface) 210B, and a side surface 210C surrounding a space between the first surface 210A and the second surface 210B. In an embodiment, the housing 210 may refer to a structure which forms a portion of the first surface 210A, the second surface 210B, and the side surfaces 210C of FIG. 2. According to an embodiment, at least a portion of the first surface 210A may be formed by a front plate 202 (e.g., a glass plate or polymer plate including various coating layers) which is at least partially substantially transparent. The second surface 210B may be formed by a rear plate 211 which is substantially opaque. The rear plate 211 may be formed of (or include), for example, coated or tinted glass, ceramic, a polymer, a metal (e.g., aluminum, stainless steel (STS), or magnesium), or a combination of at least two of these materials. The side surface 210C may be coupled to the front plate 202 and the rear plate 211 and formed by a side structure (or “side bezel structure”) 218 including a metal and/or a polymer. In an embodiment, the rear plate 211 and the side structure 218 may be integrally formed and include the same material (e.g., a metal material such as aluminum). As being integrally formed, elements may form a unitary body or a single body, without being limited thereto.

While not shown, the front plate 202 may include extended area(s) which are bent and extend seamlessly from at least a portion of an edge toward the rear plate 211. In an embodiment, the front plate 202 (or the rear plate 211) may include only one of the areas bent and extended toward the rear plate 211 (or the front plate 202) at one edge of the first surface 210A. According to an embodiment, the front plate 202 or the rear plate 211 may have a substantially flat shape. For example, it may not include any bent and extended area. When a bent and extended area is included, the electronic device 101 may have a smaller thickness in a portion including the bent and extended area than in the other portions.

According to an embodiment, the electronic device 101 may include at least one of a display 220, audio modules 203, 207, and 214, sensor modules 204 and 219, camera modules 205, 212, and 213, key input devices 217, a light emitting element 206, and connector holes 208 and 209. In an embodiment, the electronic device 101 may not be provided with at least one (e.g., a key input device 217 or the light emitting element 206) of the components or may additionally include other components.

The display 220 may be visually exposed, for example, through a substantial portion of the front plate 202. In an embodiment, at least a portion of the display 220 may be visually exposed through the front plate 202 forming the first surface 210A or a portion of the side surface 210C. In an embodiment, a corner of the display 220 may be formed substantially in the same shape as that of an adjacent periphery of the front plate 202. In an embodiment (not shown), a gap between the periphery of the display 220 and the periphery of the front plate 202 may be substantially equal to increase the visually exposed area of the display 220.

In an embodiment, a recess or an opening may be formed in a portion of a screen display area, and at least one of the audio module 214, the sensor module 204, the camera module 205, and the light emitting element 206, which is aligned with the recess or the opening, may be included. In an embodiment, at least one of the audio module 214, the sensor module 204, the camera modules 205, a fingerprint sensor, and the light emitting element 206 may be included on the rear surface of the screen display area of the display 220. In an embodiment, the display 220 may be incorporated with or disposed adjacent to a touch sensing circuit, a pressure sensor capable of measuring the intensity (pressure) of a touch, and/or a digitizer which detects a magnetic field-based stylus pen.

The audio modules 203, 207, and 214 may include a microphone hole 203 and speaker holes 207 and 214. A microphone for obtaining an external sound may be disposed in the microphone hole 203, and in an embodiment, a plurality of microphones may be disposed to detect the direction of a sound. The speaker holes 207 and 214 may include an external speaker hole 207 and a receiver hole 214 for calls. In an embodiment, the speaker holes 207 and 214 and the microphone hole 203 may be implemented as a single hole, or a speaker (e.g., a piezo speaker) may be included without the speaker holes 207 and 214.

The sensor modules 204 and 219 may generate an electrical signal or data value corresponding to an internal operating state or an external environmental state of the electronic device 101. The sensor modules 204 and 219 may include, for example, a first sensor module 204 (e.g., a proximity sensor) and/or a second sensor module (e.g., a fingerprint sensor), disposed on the first surface 210A of the housing 210, and/or a third sensor module 219 and/or a fourth sensor module (e.g., a fingerprint sensor), disposed on the second surface 210B of the housing 210. The fingerprint sensors may be disposed on the second surface 210B or the side surface 210C as well as on the first surface 210A (e.g., the display 220) of the housing 210. The electronic device 101 may further include a sensor module which is not shown, for example, at least one of a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, and an illuminance sensor.

The camera modules 205, 212, and 213 may include a first camera module 205 disposed on the first surface 210A of the electronic device 101, and a second camera module 212 and/or a flash 213 disposed on the second surface 210B. The camera modules 205 and 212 may include one or more lenses, an image sensor, and/or an ISP. The flash 213 may include, for example, a light emitting diode (LED) or a xenon lamp. In an embodiment, two or more lenses (an IR camera, a wide-angle lens, and a telephoto lens) and image sensors may be arranged on one surface of the electronic device 101. In an embodiment, the flash 213 may emit IR light, and IR light emitted by the flash 213 and reflected from an object may be received through the third sensor module 219. The electronic device 101 or the processor of the electronic device 101 may detect depth information of the object based on a time at which the IR light is received by the third sensor module 219.

The key input devices 217 may be disposed on the side surface 210C of the housing 210. In an embodiment, the electronic device 101 may not include some or any of the key input devices 217, and the key input devices 217 which are not included may be implemented in other forms such as soft keys on the display 220. In an embodiment, the key input devices 217 may include a sensor module 316 disposed on the second surface 210B of the housing 210.

The light emitting element 206 may be disposed, for example, on the first surface 210A of the housing 210. The light emitting element 206 may provide, for example, state information about the electronic device 101 in the form of light. In an embodiment, the light emitting element 206 may provide, for example, a light source interworking with an operation of the camera module 205. The light emitting element 206 may include, for example, a light emitting diode (LED), an IR LED, and a xenon lamp.

The connector holes 208 and 209 may include a first connector hole 208 capable of accommodating a connector (e.g., a USB connector) for transmitting and receiving power and/or data to and from an external electronic device and/or a second connector hole (e.g., an earphone jack) 209 capable of accommodating a connector for transmitting and receiving an audio signal to and from an external electronic device.

FIG. 4 is an exploded perspective view illustrating a front surface of an electronic device according to an embodiment of the disclosure.

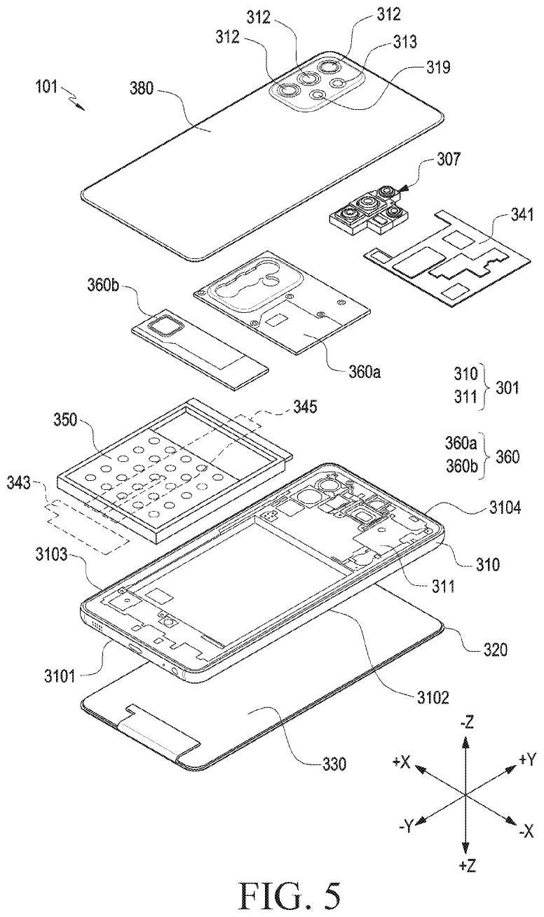

FIG. 5 is an exploded perspective view illustrating a rear surface of an electronic device according to an embodiment of the disclosure.

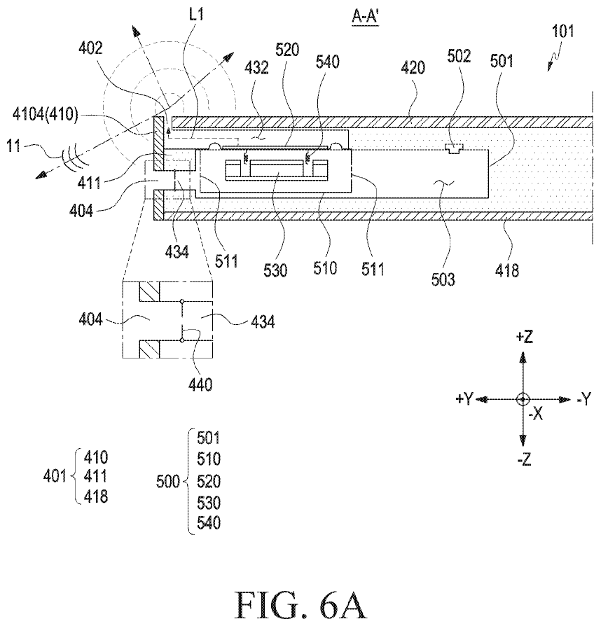

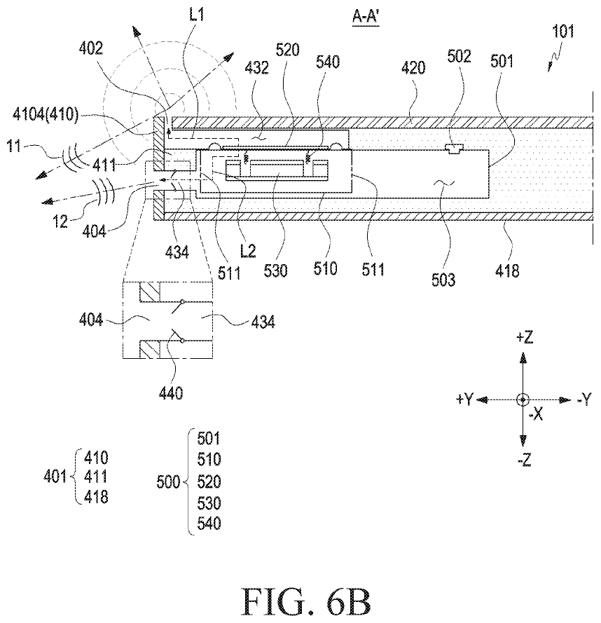

The embodiments of FIGS. 4 and 5 may be combined with the embodiments of FIGS. 1 to 3 or the embodiments of FIGS. 6A to 12.

Referring to FIGS. 4 and 5, the electronic device 101 (e.g., the electronic device 101 of FIG. 1 or the electronic device 101 of FIG. 2 or 3) may include a side structure 310, a first support member 311 (e.g., a bracket), a front plate 320 (e.g., the front plate 202 of FIG. 2), a display 330 (e.g., the display 220 of FIG. 2), at least one printed circuit board (or a board assembly) 341 and 343, a battery 350, a second support member 360 (e.g., a rear case), an antenna, a camera assembly 307, and a rear plate 380 (e.g., the rear plate 211 of FIG. 3). When including a plurality of printed circuit boards 341 and 343, the electronic device 101 may include at least one flexible connection member 345 to electrically connect different printed circuit boards to each other. For example, the printed circuit boards 341 and 343 may include a first circuit board 341 disposed above (e.g., a +Y-axis direction) of the battery 350 and a second circuit board 343 disposed below (e.g., a-Y-axis direction) thereof, and the flexible connection member 345 may electrically connect the first circuit board 341 and the second circuit board 343 to each other.

According to an embodiment, the electronic device 101 may not be provided with at least one (e.g., the first support member 311 or the second support member 360) of the components or may additionally include other components. At least one of the components of the electronic device 101 may be identical or similar to at least one of the components of the electronic device 101 in FIGS. 1 to 3, and any redundant description will be omitted below.

According to an embodiment, at least a portion of the first support member 311 may be provided to have a flat plate shape. In an embodiment, the first support member 311 may be disposed inside the electronic device 101 and connected to the side structure 310, or may be formed integrally with the side structure 310. The first support member 311 may be formed of, for example, a metal material and/or a non-metallic (e.g., polymer) material. When the first support member 311 is formed at least partially of a metal material, the side structure 310 or a portion of the first support member 311 may function as an antenna. The first support member 311 may have one surface coupled to a display 330 and the other surface coupled to the printed circuit boards 341 and 343. A processor, memory, and/or an interface may be mounted on one or more of the printed circuit boards 341 and 343. The processor may include, for example, one or more of a central processing unit, an application processor, a graphics processing unit, an image signal processor, a sensor hub processor, or a communication processor.

According to an embodiment, the first support member 311 and the side structure 310 may be combined to be referred to as a front case or a housing 301. In an embodiment, the housing 301 may be generally understood as a structure for receiving, protecting, or disposing the printed circuit boards 341 and 343 or the battery 350. In an embodiment, the housing 301 may be understood as including a structure which may be visually or tactilely recognized by a user on the exterior of the electronic device 101, for example, the side structure 310, the front plate 320, and/or the rear plate 380. In an embodiment, the ‘front or rear surface of the housing 301’ may refer to the first surface 210A of FIG. 2 or the second surface 210B of FIG. 3. In an embodiment, the first support member 311 may be located between the front plate 320 (e.g., the first surface 210A of FIG. 2) and the rear plate 380 (e.g., the second surface 210B of FIG. 3) and function as a structure on which electrical/electronic components such as the printed circuit boards 341 and 343 or the camera assembly 307 are disposed.

According to an embodiment, the side structure 310 may include at least one sidewall 3101, 3102, 3103, and 3104. The at least one sidewall 3101, 3102, 3103, and 3104 may include a first sidewall 3101, a second sidewall 3102, a third sidewall 3103, or a fourth sidewall 3104. The sidewalls may be defined and/or referred to as side surfaces.

According to an embodiment, the first sidewall 3101 may be defined and/or referred to as a lower wall of the electronic device 101.

According to an embodiment, the second sidewall 3102 may extend from the first sidewall 3101. The second sidewall 3102 may be disposed substantially perpendicular to the first sidewall 3101. For example, the second sidewall 3102 may extend from one end (e.g., an end facing a −X direction in FIGS. 4 and 5) of the first sidewall 3101.

According to an embodiment, the third sidewall 3103 may extend from the first sidewall 3101. The third sidewall 3103 may be disposed substantially perpendicular to the first sidewall 3101. For example, the third sidewall 3103 may extend from the other end (e.g., an end facing a +X direction in FIGS. 4 and 5) of the first sidewall 3101. The third sidewall 3103 may be disposed substantially parallel to the second sidewall 3102.

According to an embodiment, the fourth sidewall 3104 may be defined and/or referred to as an upper wall of the electronic device 101.

According to an embodiment, the fourth sidewall 3104 may extend from one end (e.g., an end facing the +Y direction in FIGS. 4 and 5) of the second sidewall 3102. The fourth sidewall 3104 may extend from one end (e.g., an end facing the +Y direction in FIGS. 4 and 5) of the third sidewall 3103.

According to an embodiment, the fourth sidewall 3104 may be disposed substantially perpendicular to the second sidewall 3102 and/or the third sidewall 3103. Further, the fourth sidewall 3104 may be disposed substantially parallel to the first sidewall 3101.

According to an embodiment, the first sidewall 3101, the second sidewall 3102, the third sidewall 3103, and the fourth sidewall 3104 may each include an inner surface facing the inside of the electronic device 101 and an outer surface facing the outside of the electronic device 101.

According to an embodiment, the first sidewall 3101, the second sidewall 3102, the third sidewall 3103, and the fourth sidewall 3104 may be integrally formed. According to an embodiment, the first sidewall 3101, the second sidewall 3102, the third sidewall 3103, and the fourth sidewall 3104 may be manufactured as separate members and assembled into the single side structure 310.

According to an embodiment, the first sidewall 3101, the second sidewall 3102, the third sidewall 3103, and the fourth sidewall 3104 may each be formed of a metallic material and/or a non-metallic material (e.g., polymer).

According to an embodiment, the memory may include, for example, volatile memory or non-volatile memory.

According to an embodiment, the interface may include, for example, a high definition multimedia interface (HDMI), a universal serial bus (USB) interface, an SD card interface, and/or an audio interface. The interface may, for example, electrically or physically connect the electronic device 101 to an external electronic device, and may include a USB connector, an SD card/MMC connector, or an audio connector.

According to an embodiment, the second support member 360 may include, for example, an upper support member 360a and a lower support member 360b. In an embodiment, the upper support member 360a may be disposed to surround the printed circuit boards 341 and 343 (e.g., the first circuit board 341), together with a portion of the first support member 311. For example, the upper support member 360a of the second support member 360 may be disposed to face the first support member 311 with the first circuit board 341 interposed therebetween. In an embodiment, the lower support member 360b of the second support member 360 may be disposed to face the first support member 311 with the second circuit board 343 interposed therebetween. A circuit device (e.g., a processor, a communication module, or memory) implemented in the form of an integrated circuit chip or various electrical/electronic components may be disposed on the printed circuit boards 341 and 343, and according to an embodiment, the printed circuit boards 341 and 343 may be provided with an electromagnetic shielding environment from the second support member 360. In an embodiment, the lower support member 360b may be used as a structure on which electrical/electronic components such as a speaker module and an interface (e.g., a USB connector, an SD card/MMC connector, or an audio connector) may be disposed. In an embodiment, electrical/electronic components such as a speaker module and an interface (e.g., a USB connector, an SD card/MMC connector, or an audio connector) may be disposed on an additional printed circuit board not shown. For example, the lower support member 360b may be disposed to surround the additional printed circuit board together with another portion of the first support member 311. The speaker module or the interface disposed on the additional printed circuit board not shown or the lower support member 360b may be disposed to correspond to the audio module 207 or the connector holes 208 and 209 of FIG. 2.

According to an embodiment, the battery 350, which is a device for supplying power to at least one component of the electronic device 101, may include, for example, a non-rechargeable primary battery, a rechargeable secondary battery, or a fuel cell. At least a portion of the battery 350 may be disposed substantially on the same plane as (e.g., coplanar with), for example, the printed circuit boards 341 and 343. The battery 350 may be integrally disposed within the electronic device 101, and may also be detachably disposed in the electronic device 101.

Although not shown, the antenna may include a conductive pattern implemented on the surface of the second support member 360, for example, by laser direct structuring. In an embodiment, the antenna may include a printed circuit pattern formed on the surface of a thin film, and the thin film-shaped antenna may be disposed between the rear plate 380 and the battery 350. The antenna may include, for example, a near field communication (NFC) antenna, a wireless charging antenna, and/or a magnetic secure transmission (MST) antenna. The antenna may, for example, perform short-range communication with an external device or wirelessly transmit and receive power required for charging. In an embodiment, another antenna structure may be formed by a portion or combination of the side structure 310 and/or the first support member 311.

According to an embodiment, the camera assembly 307 may include at least one camera module. Inside the electronic device 101, the camera assembly 307 (or the at least one camera module) may receive at least a portion of light incident through an optical hole or camera windows 312, 313, and 319. In an embodiment, the camera assembly 307 may be disposed on the first support member 311 at a location adjacent to the printed circuit boards 341 and 343. In an embodiment, the camera module(s) of the camera assembly 307 may be generally aligned with any one of the camera windows 312, 313, and 319 and at least partially surrounded by the second support member 360 (e.g., the upper support member 360a).

According to an embodiment, the electronic device 101 may include the flexible connection member 345. The flexible connection member 345 may include a flexible flat cable (FFC), a flexible printed circuit board (FPCB), or a board-to-board (B2B) connector.

According to an embodiment, the flexible connection member 345 may be at least partially bendable. For example, the flexible connection member 345 may be configured to be at least partially folded or unfolded.

According to an embodiment, the flexible connection member 345 may electrically connect the first circuit board 341 (e.g., a main circuit board) and at least one electrical component to each other. For example, one end of the flexible connection member 345 may be physically and/or electrically connected to at least a portion of the first circuit board 341. For example, the other end of the flexible connection member 345 may be physically and/or electrically connected to at least a portion of the at least one electrical component. The at least one electrical component may include, for example, the second circuit board 343 (e.g., a sub-circuit board). However, the at least one electrical component is not limited thereto and may include various electrical components (e.g., an antenna, a speaker, a battery, a display, or a sensor).

According to an embodiment, the flexible connection member 345 may be configured to transfer power or an electrical signal from the first circuit board 341 to the at least one electrical component. The flexible connection member 345 may be configured to transfer power or an electrical signal from the at least one electrical component to the first circuit board 341. The electrical signal may include a control signal, a power signal, or a communication signal.

FIG. 6A is a cross-sectional view taken along line A-A′ of FIG. 2 according to an embodiment of the disclosure.

FIG. 6B is a cross-sectional view taken along line A-A′ of FIG. 2 according to an embodiment of the disclosure.

FIG. 6A may be a diagram illustrating a first state of the electronic device, and FIG. 6B may be a diagram illustrating a second state of the electronic device. For example, the first state of the electronic device may be a state in which a second sound is not output through a second opening, so that a sound output through a first opening is not attenuated. For example, the second state of the electronic device may be a state in which the sound output through the first opening is attenuated by the second sound output through the second opening.

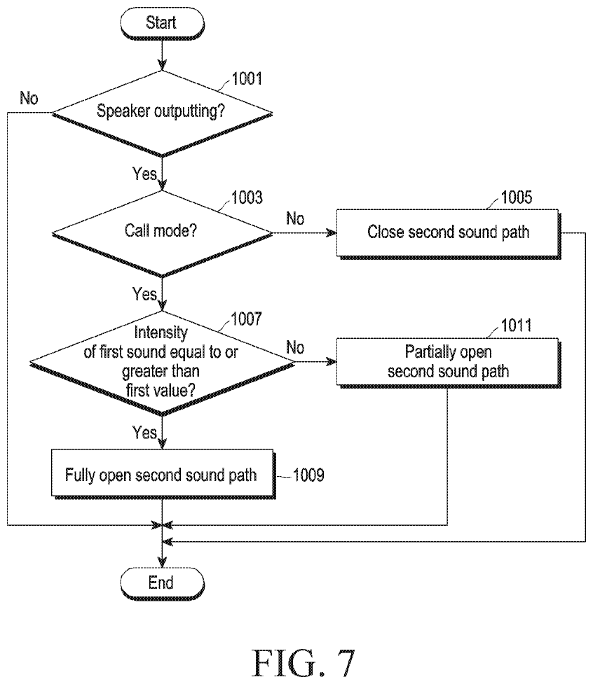

The embodiments of FIGS. 6A and 6B may be combined with the embodiments of FIGS. 1 to 5 and/or the embodiments of FIGS. 7 to 20.

Referring to FIGS. 6A and 6B, the electronic device 101 (e.g., the electronic device 101 of FIG. 1 or the electronic device 101 of FIGS. 2 to 5) may include a housing 401, a display 420, a first sound path 432, a second sound path 434, or a speaker 500.

The configuration of the housing 401 in FIGS. 6A and 6B may be identical in part or in whole to the configuration of the housing 210 in FIGS. 2 and 3, or the housing 301 in FIGS. 4 and 5. The configuration of the display 420 in FIGS. 6A and 6B may be identical in part or in whole to the configuration of the display module 160 in FIG. 1, the display 220 in FIGS. 2 and 3, or the display 330 in FIGS. 4 and 5. The configuration of the speaker 500 in FIGS. 6A and 6B may be identical in part or in whole to the configuration of the sound output module 155 in FIG. 1 or the audio module 170 in FIG. 1.

According to an embodiment, the housing 401 may form at least a portion of the exterior of the electronic device 101. The housing 401 may include a side structure 410 (e.g., the side structure 310 of FIGS. 4 and 5), a support member 411 (e.g., the first support member 311 of FIGS. 4 and 5), or a rear plate 418 (e.g., the rear plate 380 of FIGS. 4 and 5).

According to an embodiment, the side structure 410 may form at least a portion of a side surface (e.g., the side surface 210C of FIGS. 2 and 3) of the electronic device 101 and/or the housing 401. The side structure 410 may include at least one sidewall (e.g., the at least one sidewall 3101, 3102, 3103, and 3104 of FIGS. 4 and 5).

According to an embodiment, the side structure 410 may be formed integrally with the support member 411, or may be formed as a separate member and assembled with the support member 411.

According to an embodiment, the support member 411 may be disposed between the display 420 and the rear plate 418. The support member 411 may function as a structure for disposing electrical/electronic components such as a printed circuit board (e.g., the printed circuit boards 341 and 343 of FIGS. 4 and 5), a camera assembly (e.g., the camera assembly 307 of FIGS. 4 and 5), or the speaker 500.

According to an embodiment, the display 420 may be disposed on one surface (e.g., a surface facing a +Z direction in FIGS. 6A and 6B) of the support member 411. A printed circuit board may be disposed on the other surface (e.g., a surface facing a −Z direction in FIGS. 6A and 6B) of the support member 411.

According to an embodiment, the rear plate 418 may form at least a portion of the rear surface (e.g., the second surface 210B of FIGS. 2 and 3) of the electronic device 101 and/or the housing 401. The rear plate 418 may cover at least a portion of the support member 411. Various electrical/electronic components may be disposed and/or accommodated between the rear plate 418 and the support member 411.

According to an embodiment, the display 420 may be disposed on one surface of the support member 411 (e.g., the surface facing the +Z direction in FIGS. 6A and 6B). Although not shown, a front plate (e.g., the front plate 220 of FIGS. 2 and 3 or the front plate 320 of FIGS. 4 and 5) may be disposed on a front surface of the display 420. The front plate may be defined and/or interpreted as a portion of the configuration of the housing 401. The front plate may form at least a portion of the front surface (e.g., the first surface 210A of FIGS. 2 and 3) of the electronic device 101 and/or the housing 401. Depending on an embodiment, the display 420 may be defined as forming the front surface of the electronic device 101 and/or the housing 401.

According to an embodiment, the speaker 500 may include a cover housing 501, a case 510, a diaphragm 520, a magnet 530, or a voice coil 540.

According to an embodiment, the cover housing 501 may include a resonance space 503. For example, the cover housing 501 may form the resonance space 503. The resonance space 503 may be a space in which vibrations generated by the speaker 500 may resonate. For example, as vibrations generated by the diaphragm 520 resonate within the resonance space 503, the acoustic performance of the speaker 500 may be improved. The cover housing 501 may be defined and/or referred to as a speaker enclosure or a speaker cabinet.

According to an embodiment, the cover housing 501 may be disposed inside the housing 401. For example, the cover housing 501 may be disposed or positioned on the support member 411. The cover housing 501 may include an exterior which allows the resonance space 503 to be formed or defined therein. According to an embodiment, the cover housing 501 may include a case which separates the internal space of the housing 401 from the resonance space 503. According to an embodiment, the cover housing 501 may include a sealing member which prevents a sound from leaking from the resonance space 503 into the interior of the housing 401. According to an embodiment, the cover housing 501 may be defined and/or interpreted as a partial configuration of the support member 411 configured to form the resonance space 503. For example, the resonance space 503 may be provided as a space formed by the shape or structure of the support member 411.

According to an embodiment, the cover housing 501 may include a vent 502. The vent 502 may be formed in at least a portion of the cover housing 501. The vent 502 may form a path through which air flows between the internal space of the speaker 500 and the internal space of the housing 401. For example, the vent 502 may allow the air pressure difference between the internal space of the speaker 500 and the internal space of the housing 401 to be limited or reduced. The vent 502 may restrict and/or reduce lifting or separation of the diaphragm 520 from the case 510 by limiting the air pressure difference between the internal space of the speaker 500 and the internal space of the housing 401.

According to an embodiment, the case 510 may be disposed in the cover housing 501. The speaker components 520, 530, and 540 may be disposed in the case 510. For example, the diaphragm 520 may be disposed in the case 510. The case 510 may accommodate the magnet 530 or the voice coil 540. For example, the cover housing 501 may at least partially cover the speaker components 520, 530, and 540. The cover housing 501 may at least partially surround the speaker components 520, 530, and 540.

According to an embodiment, the case 510 may include a first mesh 511. The first mesh 511 may include at least one hole. For example, the first mesh 511 may be a single hole or a plurality of holes formed in the case 510. The first mesh 511 may form a passage through which sound or air may flow between the internal space of the case 510 and the second sound path 434. The first mesh 511 may form a passage through which sound or air may flow between the internal space of the case 510 and the resonance space 503 of the cover housing 501. The case 510 may be configured to support at least a portion of the diaphragm 520.

According to an embodiment, the diaphragm 520 may be disposed on one surface of the case 510. The diaphragm 520 may include a first surface (e.g., a surface facing the +Z direction in FIGS. 6A and 6B) or a second surface (e.g., a surface facing the −Z direction in FIGS. 6A and 6B). The first surface of the diaphragm 520 may face the first sound path 432. The first surface of the diaphragm 520 may be associated with or acoustically connected to the first sound path 432 and a first opening 402. The first surface of the diaphragm 520 may face the display 420. The second surface of the diaphragm 520 may face the magnet 530. The second surface of the diaphragm 520 may be associated with or acoustically connected to the second sound path 434 and a second opening 404. The first surface of the diaphragm 520 may be defined as one side of the diaphragm 520. The second surface of the diaphragm 520 may be defined as the other side of the diaphragm 520. The second surface of the diaphragm 520 may face opposite to the first surface of the diaphragm 520. The second surface of the diaphragm 520 may be defined and/or referred to as another surface of the diaphragm 520.

According to an embodiment, the voice coil 540 may be disposed inside the case 510. The magnet 530 may be disposed inside the case 510. The voice coil 540 may be positioned within a magnetic field region of the magnet 530 (e.g., a permanent magnet).

According to an embodiment, the speaker 500 may receive an electrical signal for audio information through an audio module (e.g., the audio module 170 of FIG. 1). The speaker 500 may supply current to the voice coil 540 based on the received electrical signal. A force (e.g., magnetic force) by the magnet 530 may be applied to the voice coil 540 according to the intensity of the current supplied to the voice coil 540. The diaphragm 520 may vibrate according to the force applied to the voice coil 540. As the diaphragm 520 vibrates, a sound may be generated from the diaphragm 520, and the speaker 500 may output the sound. According to an embodiment, the case 510, the diaphragm 520, the magnet 530, and the voice coil 540 may be defined as a speaker module or a speaker unit.

According to an embodiment, when the diaphragm 520 is vibrated, a first sound generated from the first surface (e.g., the surface facing the +Z direction in FIGS. 6A and 6B) or the one side of the diaphragm 520 may have a phase substantially opposite to a second sound generated from the second surface (e.g., the surface facing the −Z direction in FIGS. 6A and 6B) or the other side of the diaphragm 520.

According to an embodiment, the electronic device 101 may include the first sound path 432. The first sound path 432 may be acoustically connected to the first surface (e.g., the surface facing the +Z direction in FIGS. 6A and 6B) of the diaphragm 520. The first sound path 432 may be associated with the one side (e.g., the first surface) of the diaphragm 520 and the first opening 402. For example, a sound generated from the first surface of the diaphragm 520 may be output to the outside of the electronic device 101 through the first sound path 432 and the first opening 402. For example, the first surface of the diaphragm 520 may be exposed to the first sound path 432. The first sound path 432 may be defined and/or referred to as a first duct or a first conduit formed inside the housing 401. The first sound path 432 may be formed or defined by the support member 411. The first sound path 432 may be a space formed between the support member 411 and the display 420. The first sound path 432 may also be formed by a duct member disposed inside the housing 401. The first sound path 432 may be positioned at least partially between the display 420 and the speaker 500. The first sound path 432 may provide a space or path through which a sound generated from the diaphragm 520 is output. The first sound path 432 may be acoustically connected to the first opening 402 (e.g., a first external opening).

According to an embodiment, the electronic device 101 and/or the housing 401 may include the first opening 402 (e.g., the receiver hole 214 of FIG. 2). The first opening 402 may be formed to face the front (e.g., the +Z direction in FIG. 6A) of the electronic device 101 and/or the housing 401. For example, the first opening 402 may face a direction in which the display 420 faces. The first opening 402 may be positioned adjacent to a first edge (e.g., an edge facing the +Y direction in FIGS. 6A and 6B) of the display 420. The first opening 402 may be positioned adjacent to a fourth sidewall (e.g., the fourth sidewall 3104 of FIGS. 4 and 5) of the side structure 410.

According to an embodiment, the first opening 402 may be adjacent to an upper edge (e.g., an edge facing the +Y direction in FIGS. 6A and 6B) of the display 420. The first opening 402 may be formed on the front surface (e.g., the surface facing the +Z direction in FIGS. 6A and 6B) of the electronic device 101.

According to an embodiment, the first opening 402 may be a hole defined or formed by the housing 401. For example, the first opening 402 may be a hole formed in at least a portion of the side structure 410 and/or at least a portion of the support member 411.

According to an embodiment, the first opening 402 may be a hole defined or formed by at least a portion of the housing 401 and the first edge (e.g., the edge facing the +Y direction in FIGS. 6A and 6B) of the display 420. For example, the first opening 402 may be a hole surrounded by at least a portion of the side structure 410 and/or the first edge of the display 420.

According to an embodiment, the first opening 402 may be acoustically connected to the first sound path 432.

According to an embodiment, the electronic device 101 may include the second sound path 434. The second sound path 434 may be acoustically connected to the second surface (e.g., the surface facing the −Z direction in FIGS. 6A and 6B) of the diaphragm 520. The second sound path 434 may be associated with the other side (e.g., the second surface) of the diaphragm 520 and the second opening 404. For example, a sound generated from the second surface of the diaphragm 520 may be output to the outside of the electronic device 101 through the second sound path 434 and the second opening 404. The second sound path 434 may be defined and/or referred to as a second duct or a second conduit formed inside the housing 401. The second sound path 434 may be formed or defined by the support member 411. The second sound path 434 may also be formed by a duct member disposed inside the housing 401. The second sound path 434 may be positioned at least partially between the display 420 and the rear plate 418. The second sound path 434 may provide a space or path through which a sound generated from the diaphragm 520 is output. The second sound path 434 may be acoustically connected to the second opening 404 (e.g., a second external opening). That is, a sound generated from the diaphragm 520 may be output to outside the electronic device 101, via the second sound path 434 and the second opening 404.

According to an embodiment, the electronic device 101 and/or the housing 401 may include the second opening 404. The second opening 404 may be formed to face a side (e.g., the +Y direction in FIG. 6A) of the electronic device 101 and/or the housing 401. For example, the second opening 404 may face a direction in which the fourth sidewall 4104 of the side structure 410 faces. For example, the second opening 404 may face a direction different from the direction in which the first opening 402 faces.

According to an embodiment, the second opening 404 may be a hole defined or formed by the housing 401. For example, the second opening 404 may be a hole formed in at least a portion (e.g., the fourth sidewall 4104) of the side structure 410. The fourth sidewall 4104 may form at least a portion of a side surface of the electronic device 101.

According to an embodiment, the first opening 402 may be formed on the front surface of the electronic device 101. The second opening 404 may be formed on another surface of the electronic device 101. The other surface of the electronic device 101 may be formed on a side surface (e.g., the surface facing the +Y direction in FIGS. 6A and 6B) of the electronic device 101.

According to an embodiment, the second opening 404 may be acoustically connected to the second sound path 434.

According to an embodiment, the electronic device 101 may further include at least one door 440. The at least one door 440 may be positioned in the second sound path 434. The at least one door 440 may be configured to open or close at least a portion of the second sound path 434. The at least one door 440 may be defined and/or referred to as an opening/closing member or a closer.

According to an embodiment, the at least one door 440 may open or close at least a portion of the second sound path 434 through an opening and closing method by piezoelectric elements, an opening and closing method by static electricity, an opening and closing method by electromagnetism, an opening and closing method by a polymer actuator, or an opening and closing method by a conductive polymer.

According to an embodiment, the at least one door 440 may at least partially open or at least partially close the second sound path 434. For example, the at least one door 440 may open the second sound path 434 to a maximum extent or close the second sound path 434 to a maximum extent. Further, the at least one door 440 may be configured to open or close to a degree between a maximum open state and a maximum closed state of the second sound path 434.

According to an embodiment, when the state of the electronic device 101 is the first state, the at least one door 440 may close at least a portion of the second sound path 434. According to an embodiment, when the state of the electronic device 101 is the second state, the at least one door 440 may open at least a portion of the second sound path 434. That is, an amount of a sound (e.g., at least one of the first sound and the second sound) which is incident to a respective external opening (e.g., like the first external opening 402 and the second external opening 404) is changeable within a respective sound path (e.g., the first sound path 432 and the second sound path 434).

According to an embodiment, the first state of the electronic device 101 may be defined as a general sound output state through the speaker 500. For example, in the first state, a sound provided from the first surface of the diaphragm 520 may be output to the outside of the electronic device 101 through the first sound path 432 and the first opening 402, as shown in a path L1 in FIGS. 6A and 6B. In the first state, as at least a portion of the second sound path 434 is closed, a sound provided from the second surface of the diaphragm 520 may be output to the outside of the electronic device 101 through the second sound path 434 and the second opening 404. In the first state, the sound output to the outside through the first opening 402 may be radiated toward the front (e.g., the +Z direction in FIGS. 6A and 6B) of the housing 401 and toward a side of the housing 401 (e.g., the +Y direction in FIGS. 6A and 6B).

According to an embodiment, the second state of the electronic device 101 may be defined as an audio output state for a call through the speaker 500. For example, the second state may be a state in which a user places the electronic device 101 in contact with or adjacent to the user's face and ear for a call. For example, the second state may be a state in which a proximity sensor disposed on the display 420 detects that the user's body part (e.g., face and/or ear) is located within a specified distance. For example, in the second state, a sound provided from the first surface of the diaphragm 520 may be output to the outside of the electronic device 101 through the first sound path 432 and the first opening 402, as shown in the path L1 in FIGS. 6A and 6B. In the second state, as at least a portion of the second sound path 434 is opened, a sound provided from the second surface of the diaphragm 520 may be output to the outside of the electronic device 101 through the second sound path 434 and the second opening 404.

According to an embodiment, the first mesh 511 may be directly connected to the second sound path 434. For example, a portion of the case 510 may be disposed to cover the second sound path 434. A sound provided from the second surface of the diaphragm 520 may be output to the outside of the electronic device 101 through the internal space of the case 510, the first mesh 511, the second sound path 434, and the second opening 404. The first mesh 511 may be spaced apart from the second sound path 434. For example, a portion of the case 510 may be disposed to be spaced apart from the second sound path 434. The sound provided from the second surface of the diaphragm 520 may be output through the internal space of the case 510, the first mesh 511, the internal space of the cover housing 501, the second sound path 434, and the second opening 404. In the second state, the sound output to the outside through the first opening 402 may be radiated toward the front (e.g., the +Z direction in FIGS. 6A and 6B) of the housing 401 and toward the side of the housing 401 (e.g., the +Y direction in FIGS. 6A and 6B). In the second state, the sound output through the second opening 404 may be radiated toward the side of the housing 401 (e.g., the +Y direction in FIGS. 6A and 6B).

According to an embodiment, when the state of the electronic device 101 is the second state, a first sound generated from the first surface (e.g., the surface facing the +Z direction in FIGS. 6A and 6B) of the diaphragm 520 may be output through the first sound path 432 and the first opening 402. The first sound output through the first opening 402 may have a first phase 11 at the side of the housing 401 (e.g., the +Y direction in FIGS. 6A and 6B). A second sound generated from the second surface (e.g., the surface facing the −Z direction in FIGS. 6A and 6B) of the diaphragm 520 may be output through the second sound path 434 and the second opening 404. The second sound output through the second opening 404 may have a second phase 12 at the side of the housing 401 (e.g., the +Y direction in FIGS. 6A and 6B). The second phase 12 may have a phase (e.g., a difference of approximately 180 degrees) substantially opposite to the first phase 11. For example, the first phase 11 may be a phase formed by the vibration of the first surface of the diaphragm 520, and the second phase 12 may be a phase formed by the vibration of the second surface facing the opposite direction to the first surface of the diaphragm 520. Accordingly, the second phase 12 may be substantially opposite to the first phase 11. At the side of the housing 401, the first sound having the first phase 11 and the second sound having the second phase 12 may cancel each other out. Accordingly, when using the electronic device 101 for a call, the first sound may be output toward the front (e.g., a direction where the user's face or ear is located) of the housing 401. Also, when using the electronic device 101 for a call, the leakage of call content (e.g., call audio) to the side of the housing 401 may be restricted and/or reduced. For example, when the diaphragm 520 is vibrated and the second sound path 434 is opened, the first sound output through the first opening 402 may be configured to be attenuated by the second sound output through the second opening 404.

FIG. 7 is a flowchart illustrating a method for operating an electronic device according to an embodiment of the disclosure.

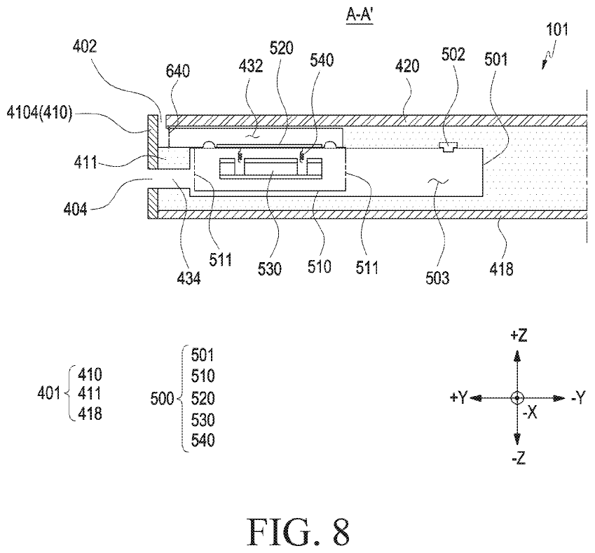

The embodiment of FIG. 7 may be combined with the embodiments of FIGS. 1 to 6B or the embodiments of FIGS. 8 to 20.

The operation method of FIG. 7 is described using the electronic device 101 of FIGS. 6A and 6B as an example, to which the operation method is not limited, and may be applied and/or understood identically or similarly to the electronic device 101 of FIGS. 7 to 17.

A method for operating the electronic device 101 will be described using FIGS. 6A to 7 as an example.

According to an embodiment, the electronic device 101 may include at least one processor (e.g., the processor 120 of FIG. 1) or memory (e.g., the memory 130 of FIG. 1). The memory may store at least one instruction. The at least one instruction, when executed by the processor, may cause the electronic device 101 to perform at least one operation. Operations performed by the electronic device 101 may be interpreted as being executed by the at least one processor.

According to an embodiment, the electronic device 101 may be configured to identify whether the speaker 500 is outputting (operation 1001). A state in which the speaker 500 is outputting may be defined as a state in which the diaphragm 520 of the speaker 500 is vibrating. For example, the electronic device 101 may be configured to identify a state in which the diaphragm 520 of the speaker 500 vibrates so that a sound is output. For example, the electronic device 101 may be configured to identify whether the diaphragm 520 and/or the speaker 500 is in operation.

According to an embodiment, the electronic device 101 may be configured to, when the speaker 500 is outputting, identify whether the state of the electronic device 101 is a call mode (operation 1003). For example, in the state where the speaker 500 is outputting, the electronic device 101 may be configured to identify whether an external object like a body part (e.g., a part of a user's body) is detected within a specified distance relative to the electronic device 101, by a first sensor module (e.g., the first sensor module or proximity sensor 204 of FIG. 2). For example, the electronic device 101 may be configured to identify the state of the electronic device 101 as a call mode, when the user's body is detected within the specified distance. For example, the electronic device 101 may be configured to identify the state of the electronic device 101 as a non-call mode, when an external object like the user's body is not detected within the specified distance.

According to an embodiment, when the state of the electronic device 101 is the non-call mode, the electronic device 101 may control the at least one door 440 to close the second sound path 434 (operation 1005). For example, when the state of the electronic device 101 is the non-call mode (e.g., a multimedia playback mode), a first sound output from one side of the diaphragm 510 may be radiated toward the front and side of the electronic device 101. For example, as the second sound path 434 is closed, the first sound may be configured not to be attenuated by a second sound associated with the second sound path 434. For example, when the application associated with the first sound is not a voice call application, the electronic device 101 may operate to close the at least one door and reduce the amount of the sound (e.g., at least one of the first sound and the second sound) which is incident to a respective external opening.

According to an embodiment, the electronic device 101 may be configured to identify whether the amplitude of the first sound is greater than or equal to a first value, when the state of the electronic device 101 is the call mode (operation 1007). The amplitude of the first sound may be defined as the intensity of a sound detected through a microphone (not shown) (e.g., the input module 150 of FIG. 1) disposed in the housing 401. For example, it may be configured to identify whether the intensity of the first sound detected by the microphone is greater than or equal to the specified first value. The microphone may be located adjacent to the first opening 402, but is not limited thereto. The amplitude of the first sound may also be defined as the intensity of a sound currently being output by the speaker 500. For example, it may be configured to identify whether the intensity of the first sound currently output from the speaker 500 is greater than or equal to the specified first value.

According to an embodiment, when the amplitude of the first sound is greater than or equal to the first value, the electronic device 101 may control the at least one door 440 such that the second sound path 434 is fully opened (operation 1009). For example, the electronic device 101 may control the at least one door 440 such that the second sound path 434 is opened to a maximum extent. The first sound output through the first sound path 432 and the first opening 402 may be attenuated by the second sound output through the second sound path 434 and the second opening 404. For example, when the volume of a leaked sound is high during the call mode, operation 1009 may improve the attenuation effect by fully opening the second sound path 434.

According to an embodiment, when the amplitude of the first sound is less than the first value, the electronic device 101 may control the at least one door 440 such that the second sound path 434 is partially opened (operation 1011). For example, the electronic device 101 may control the at least one door 440 such that the second sound path 434 is opened less than a fully opened state. For example, when the application associated with the first sound is a voice call application, the electronic device 101 may operate to at least partially open the at least one door and maintain at least a portion of the amount of a sound (e.g., the at least one of the first sound and the second sound) to be incident to a respective external opening. The first sound output through the first sound path 432 and the first opening 402 may be attenuated by the second sound output through the second sound path 434 and the second opening 404. For example, when the volume of a leaked sound is low during the call mode, fully opening the second sound path 434 may result in a smaller attenuation effect, and thus operation 1011 may improve the attenuation effect by partially opening the second sound path 434.

FIG. 8 is a cross-sectional view illustrating an electronic device according to an embodiment of the disclosure.

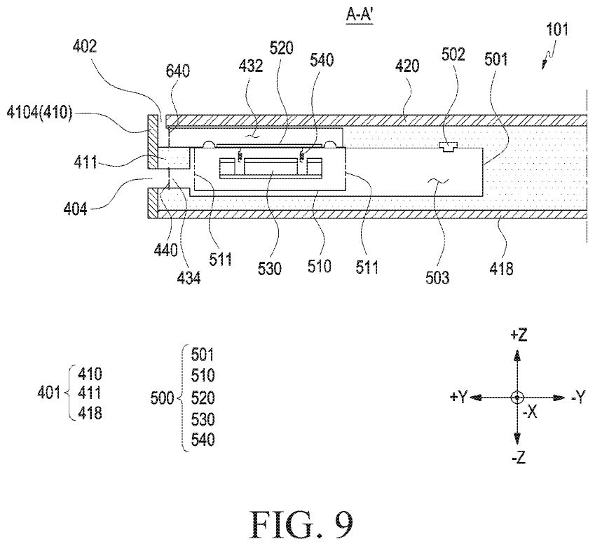

FIG. 9 is a cross-sectional view illustrating an electronic device according to an embodiment of the disclosure.

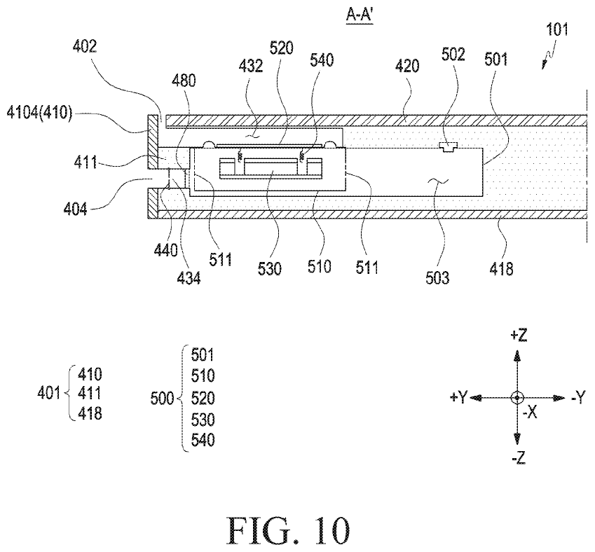

FIG. 10 is a cross-sectional view illustrating an electronic device according to an embodiment of the disclosure.

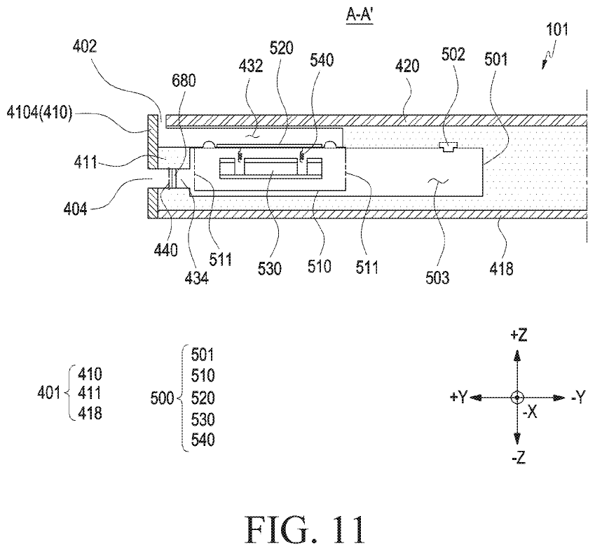

FIG. 11 is a cross-sectional view illustrating an electronic device according to an embodiment of the disclosure.

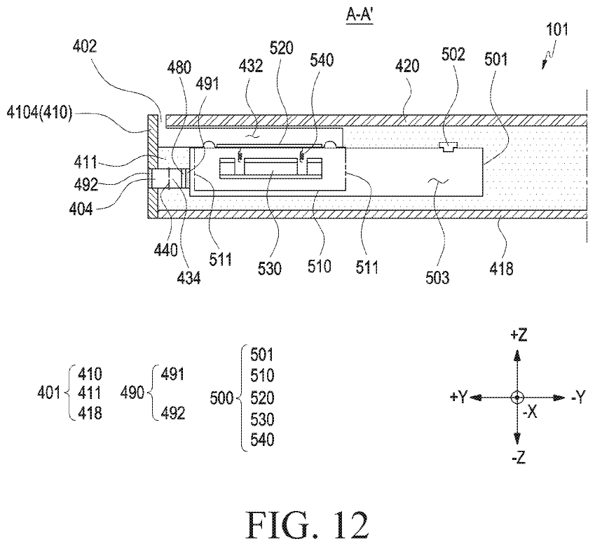

FIG. 12 is a cross-sectional view illustrating an electronic device according to an embodiment of the disclosure.

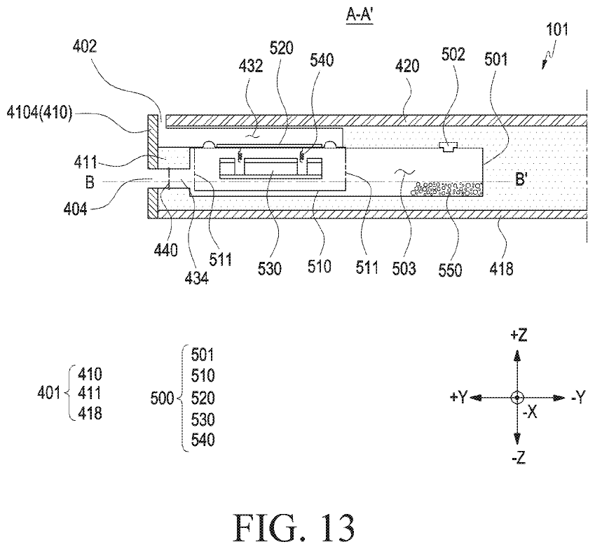

FIG. 13 is a cross-sectional view illustrating an electronic device according to an embodiment of the disclosure.

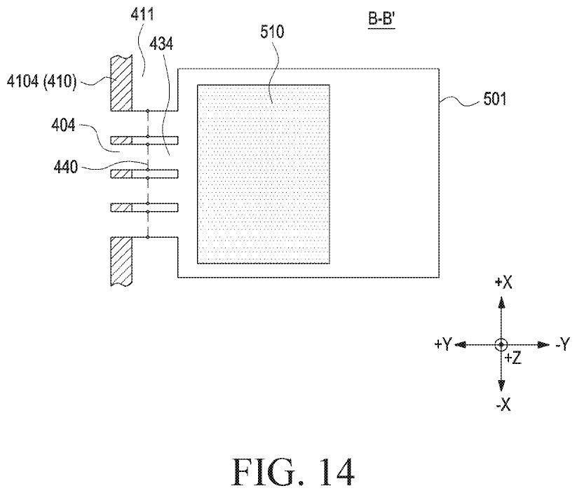

FIG. 14 is a cross-sectional view taken along line B-B′ of FIG. 13 according to an embodiment of the disclosure.

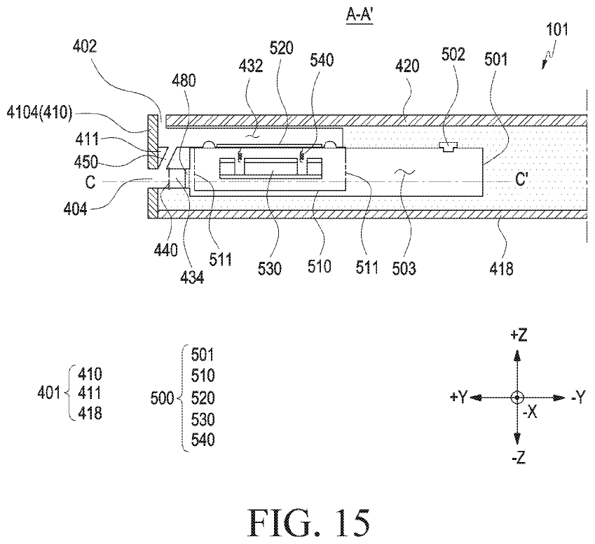

FIG. 15 is a cross-sectional view illustrating an electronic device according to an embodiment of the disclosure.

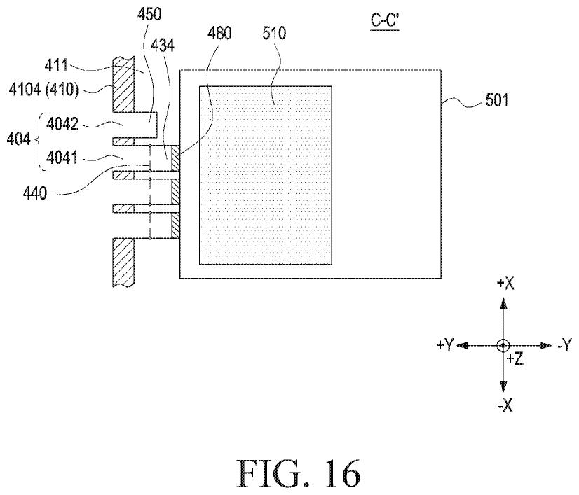

FIG. 16 is a cross-sectional view taken along line C-C′ of FIG. 15 according to an embodiment of the disclosure.

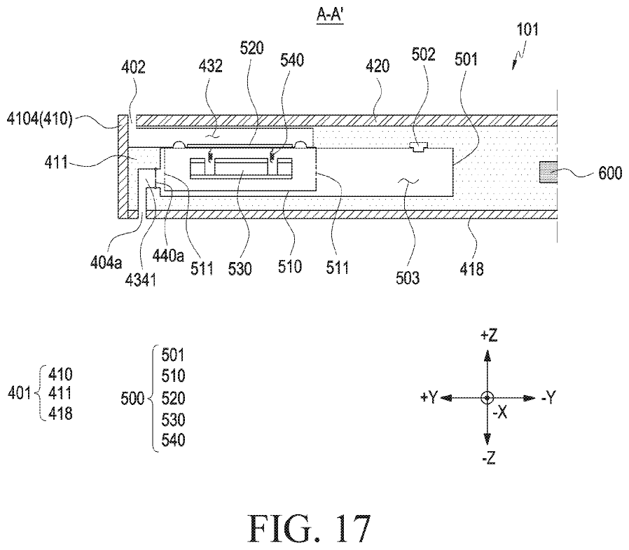

FIG. 17 is a cross-sectional view illustrating an electronic device according to an embodiment of the disclosure.

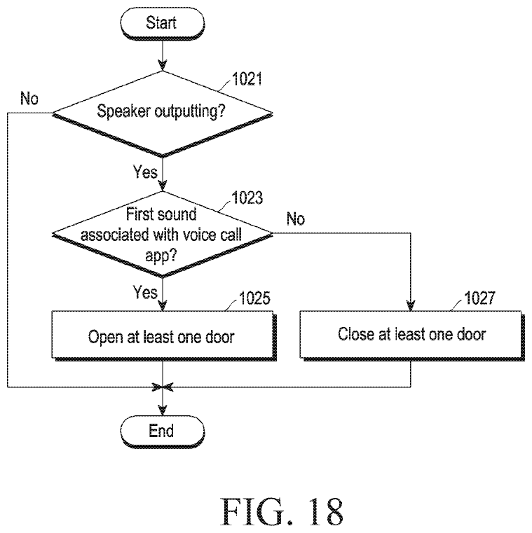

The embodiments of FIGS. 8 to 17 may be combined with the embodiments of FIGS. 1 to 7 or the embodiments of FIGS. 18 to 20.

The embodiments of FIGS. 8 to 12, the embodiment of FIG. 13, the embodiment of FIG. 15, or the embodiment of FIG. 17 are cross-sectional views illustrating the electronic device, taken along line A-A′ of FIG. 2.

Referring to FIGS. 8 to 17, the electronic device 101 (e.g., the electronic device 101 of FIG. 1, or the electronic device 101 of FIGS. 2 to 6B) may include the housing 401, the display 420, the first sound path 432, the second sound path 434, or the speaker 500. The speaker 500 may include the cover housing 501, the vent 502, the resonance space 503, the case 510, the first mesh 511, the diaphragm 520, the magnet 530, or the voice coil 540.

The configuration of the housing 401, the display 420, the first sound path 432, the second sound path 434, or the speaker 500 in FIGS. 8 to 17 may be identical in part or in whole to the configuration of the housing 401, the display 420, the first sound path 432, the second sound path 434, or the speaker 500 in FIGS. 6A and 6B. The configuration of the cover housing 501, the vent 502, the resonance space 503, the case 510, the first mesh 511, the diaphragm 520, the magnet 530, or the voice coil 540 in FIGS. 8 to 16 may be identical in part or in whole to the configuration of the cover housing 501, the vent 502, the resonance space 503, the case 510, the first mesh 511, the diaphragm 520, the magnet 530, or the voice coil 540 in FIGS. 6A and 6B.

Referring to FIGS. 8 to 17, the housing 401 may include the side structure 410 (e.g., the side structure 410 of FIGS. 6A and 6B, the support member 411 (e.g., the support member 411 of FIGS. 6A and 6B), or the rear plate 418 (e.g., the rear plate 418 of FIGS. 6A and 6B).

Referring to FIG. 8, the electronic device 101 may include at least one door 640 (e.g., the at least one door 440 of FIGS. 6A and 6B). The at least one door 640 may be configured to open or close at least a portion of the first sound path 432. The at least one door 640 may be defined and/or referred to as an opening/closing member or a closer.

According to an embodiment, in the first state, which is a general sound output state, the at least one door 640 may close the first sound path 432. In this case, as the first sound path 432 is closed, the first sound output from the first surface (e.g., a surface facing the +Z direction in FIG. 8) of the diaphragm 520 may not be output through the first opening 402. Additionally, the second sound output from the second surface (e.g., a surface facing the −Z direction in FIG. 8) of the diaphragm 520 may be output through the second sound path 434 and the second opening 404.

According to an embodiment, in the second state, which is a sound output state for a call, the at least one door 640 may open the first sound path 432. In this case, the first sound output from the first surface (e.g., the surface facing the +Z direction in FIG. 8) of the diaphragm 520 may be output through the first sound path 432 and the first opening 402. The second sound output from the second surface (e.g., the surface facing the-Z direction in FIG. 8) of the diaphragm 520 may be output through the second sound path 434 and the second opening 404. Accordingly, the first sound and the second sound having phases opposite to each other may cancel each other out at a side of the housing 401 (e.g., the +Y direction in FIG. 8).

Referring to FIG. 9, the electronic device 101 may include at least one door 440 and 640 (e.g., the at least one door 440 of FIGS. 6A and 6B, or the at least one door 640 of FIG. 8). The at least one door 440 and 640 may include a first door 440 configured to open or close at least a portion of the second sound path 434. The at least one door 440 and 640 may include a second door 640 configured to open or close at least a portion of the first sound path 432.

Referring to FIG. 10, the electronic device 101 may include at least one door 440 (e.g., the at least one door 440 of FIGS. 6A and 6B). The at least one door 440 may be configured to open or close at least a portion of the second sound path 434.

Referring to FIG. 10, the electronic device 101 may include a waterproof member 480 disposed in the second sound path 434. The waterproof member 480 may block and/or reduce external moisture from entering the interior of the speaker 500 through the second sound path 434. The waterproof member 480 may include a breathable material which allows the distribution of sound or air. For example, the waterproof member 480 may include, but is not limited to, a waterproof, breathable fabric membrane such as a Gore-Tex® material. The waterproof member 480 may be positioned between the at least one door 440 and the case 510. Depending on an embodiment, the at least one door 440 may be positioned between the waterproof member 480 and the case 510.

Referring to FIG. 11, the electronic device 101 may include at least one door 440 (e.g., the at least one door 440 of FIGS. 6A and 6B) or a waterproof member 680 (e.g., the waterproof member 480 of FIG. 10). The at least one door 440 may be configured to open or close at least a portion of the second sound path 434. The waterproof member 680 may block and/or reduce external moisture from entering the interior of the speaker 500 through the sound path 434. The waterproof member 680 may be disposed adjacent to the at least one door 440. Depending on an embodiment, the waterproof member 680 and the at least one door 440 may be integrally formed.

Referring to FIG. 12, the electronic device 101 may include at least one door 440 (e.g., the at least one door 440 of FIGS. 6A and 6B), the waterproof member 480 (e.g., the waterproof member 480 of FIG. 10), or at least one tuning member 490.

According to an embodiment, the at least one tuning member 490 may be disposed in the second sound path 434 or the second opening 404. The at least one tuning member 490 may include a metal mesh configured to tune a sound output through the second sound path 434 and the second opening 404. The metal mesh may include at least one hole. The at least one tuning member 490 may include a second mesh 491 or a third mesh 492. The second mesh 491 may be disposed in the second sound path 434. The second mesh 491 may be positioned between the waterproof member 480 and the case 510. The third mesh 492 may be disposed in the second opening 404. The second mesh 491 may be defined and/or referred to as a first acoustic mesh. The third mesh 492 may be defined and/or referred to as a second acoustic mesh.

Referring to FIG. 13, the electronic device 101 may include at least one door 440 (e.g., the at least one door 440 of FIGS. 6A and 6B).

According to an embodiment, the electronic device 101 may further include a sound absorbing member 550. The sound absorbing member 550 may be disposed within the resonance space 503. The sound absorbing member 550 may be accommodated in the resonance space 503. The sound absorbing member 550 may include a granular air-suction material. The sound absorbing member 550 may be configured to alleviate air compression in the resonance space 503 caused by the vibration of the diaphragm 520. For example, the sound absorbing member 550 may be composed of a mixture of a binder and at least one air-adsorbing material among diatomaceous earth-based elements, perlite or silicon dioxide-based elements, or zeolite-based elements. The sound absorbing member 550 may also be provided in a structure where granular air-suction materials are disposed on a sheet.

FIG. 14 is a cross-sectional view illustrating an electronic device, taken along line B-B′ of FIG. 13.

Referring to FIG. 14, the electronic device 101 may be provided with a plurality of second openings 404 and second sound paths 434. Each of the plurality of second openings 404 may be acoustically connected to a corresponding one of the plurality of second sound paths 434. A plurality of doors 440 (e.g., the at least one door 440 of FIGS. 6A and 6B) may be provided to be respectively disposed in the plurality of second sound paths 434. Each of the second sound paths 434 (e.g., sub-sound paths) may meet or be acoustically connected to a common sound path of an overall second sound path.

Referring to FIG. 15, the electronic device 101 may include at least one door 440 (e.g., the at least one door 440 of FIGS. 6A and 6B) or the waterproof member 480 (e.g., the waterproof member 480 of FIG. 10).

According to an embodiment, the electronic device 101 may further include a third sound path 450. The third sound path 450 may acoustically connect the first sound path 432 and the second sound path 434 to each other. For example, the third sound path 450 may be formed in at least a portion of the support member 411. The third sound path 450 may be acoustically connected to the first sound path 432 at one end of the third sound path 450, and the third sound path 450 may be acoustically connected to the second sound path 434 at the other end of the third sound path 450. The third sound path 450 may extend from the first sound path 432 to the second sound path 434.

According to an embodiment, a plurality of second sound paths 434 and a plurality of second openings 404 may be provided. The number of third sound paths 450 may be smaller than or equal to the number of second sound paths 434. For example, when the number of third sound paths 450 is smaller than the number of second sound paths 434, the third sound path 450 may be acoustically connected to some of the plurality of second sound paths 434 (e.g., a corresponding number of second sound paths 434), respectively. When the number of third sound paths 450 is equal to the number of second sound paths 434, the third sound paths 450 may be acoustically connected to all of the plurality of second sound paths 434 (e.g., a corresponding number of second sound paths 434), respectively.

FIG. 16 is a cross-sectional view illustrating an electronic device, taken along line C-C′ of FIG. 15.

According to an embodiment, the second opening 404 may include a (2-1)^{th} opening 4041 or a (2-2)^{th} opening 4042. The (2-1)^{th} opening 4041 as a first sub-opening may be acoustically connected to the second sound path 434. The (2-2)^{th} opening 4042 as a second sub-opening may be acoustically connected to the third sound path 450. Depending on an embodiment, the (2-2)^{th} opening 4042 may be directly connected to the third sound path 450 or indirectly connected to the third sound path 450 through the second sound path 434.

Referring to FIG. 17, the electronic device 101 may include at least one door 440a (e.g., the at least one door 440 of FIGS. 6A and 6B). The at least one door 440a may be configured to open or close at least a portion of a second sound path 4341 (e.g., the second sound path 434 of FIGS. 6A and 6B). The at least one door 440a may be defined and/or referred to as an opening/closing member or a closer.

According to an embodiment, a second opening 404a may be formed on the rear surface of the electronic device 101. For example, the second opening 404a may be formed on the rear plate 418 of the electronic device 101. The second sound path 4341 may extend from the second surface (e.g., a surface facing the −Z direction in FIG. 17) of the diaphragm 520 to the second opening 404a.

According to an embodiment, in the first state, which is a general sound output state, the at least one door 440a may close the second sound path 4341. In this case, as the second sound path 4341 is closed, the second sound output from the second surface (e.g., a surface facing the −Z direction in FIG. 17) of the diaphragm 520 may not be output through the second opening 404a. Additionally, the first sound output from the first surface (e.g., a surface facing the +Z direction in FIG. 17) of the diaphragm 520 may be output through the first sound path 432 and the first opening 402.

According to an embodiment, in the second state, which is a sound output state for a call, the at least one door 440a may open the second sound path 4341. In this case, the second sound output from the second surface (e.g., the surface facing the −Z direction in FIG. 17) of the diaphragm 520 may be output through the second sound path 4341 and the second opening 404a. The first sound output from the first surface (e.g., the surface facing the +Z direction in FIG. 17) of the diaphragm 520 may be output through the first sound path 432 and the first opening 402. Accordingly, the first sound and the second sound having phases opposite to each other may cancel each other out at a side of the housing 401 (e.g., the +Y direction in FIG. 8).

According to an embodiment, the electronic device 101 may further include another speaker 600. The other speaker 600 may be disposed inside the housing 401. The other speaker 600 may be spaced apart from the speaker 500.

According to an embodiment, the speaker 500 may be a receiver-type speaker (e.g., a speaker for providing a voice call), and the other speaker 600 may be a multimedia-type speaker (e.g., a speaker for playing a multimedia sound), to which the disclosure is not limited.

FIG. 18 is a flowchart illustrating a method for operating an electronic device according to an embodiment of the disclosure.

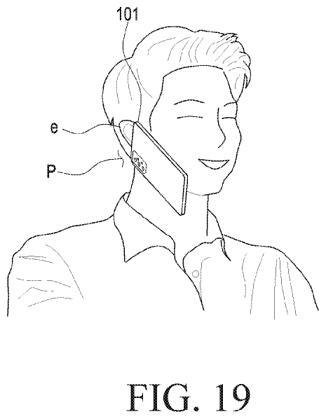

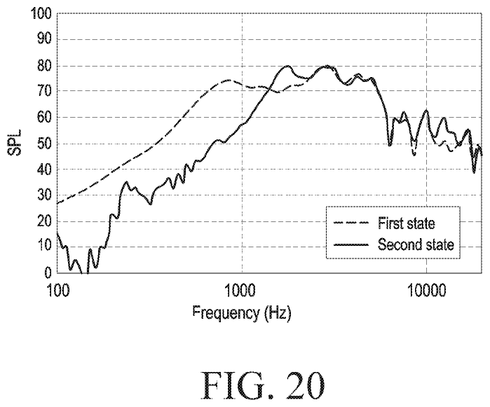

The embodiment of FIG. 18 may be combined with the embodiments of FIGS. 1 to 16 or the embodiments of FIGS. 19 and 20.

The embodiment of FIG. 18 is described using the electronic device 101 of FIGS. 6A and 6B as an example, to which the disclosure is not limited, and may be applied and/or understood identically or similarly to the electronic device 101 of FIGS. 7 to 18.

A method for operating the electronic device 101 will be described with reference to FIGS. 6A, 6B, and 18, by way of example.

According to an embodiment, the electronic device 101 may include at least one processor (e.g., the processor 120 of FIG. 1) or memory (e.g., the memory 130 of FIG. 1). The memory may store instructions. The instructions, when executed by the processor, may cause the electronic device 101 to perform at least one operation. Operations performed by the electronic device 101 may be interpreted as being executed by the at least one processor. The electronic device 101 may control the at least one door 440 to be opened and/or closed, based on execution of an application associated with a first sound.

According to an embodiment, the electronic device 101 may be configured to identify whether the speaker 500 is outputting (operation 1021). A state in which the speaker 500 is outputting may be defined as a state in which the diaphragm 520 of the speaker 500 is vibrating. For example, the electronic device 101 may be configured to identify a state in which the diaphragm 520 of the speaker 500 vibrates so that a sound is output. For example, the electronic device 101 may be configured to identify whether the diaphragm 520 or the speaker 500 is in operation.

According to an embodiment, when the speaker 500 is outputting, the electronic device 101 may be configured to identify whether the first sound output from the first surface of the diaphragm 520 is associated with a voice call application (operation 1023). For example, the electronic device 101 may be configured to identify whether the speaker 500 is outputting based on the voice call application.

According to an embodiment, based on the identification that an application associated with the first sound output from the first surface of the diaphragm 520 is the voice call application, the electronic device 101 may control the at least one door 440 to open such that the first sound is output through the first opening 402 and the second sound is output through the second opening 404 (operation 1025). For example, when the output of the speaker 500 is an output for supporting a call mode, the electronic device 101 may control the at least one door 440 to open the first sound path 432 and the second sound path 434 such that the first sound is attenuated by the second sound.

According to an embodiment, based on identification that the application associated with the first sound output from the first surface of the diaphragm 520 is an application (e.g., an application for multimedia playback) other than the voice call application, the electronic device 101 may control the at least one door 440 to close such that either the first sound through the first opening 402 or the second sound through the second opening 404 is not output. For example, when the output of the speaker 500 is an output for supporting a multimedia playback mode rather than a call mode, the electronic device 101 may control the at least one door 440 to close the second sound path 434 such that the first sound is not attenuated by the second sound.

FIG. 19 is a diagram illustrating a state of making a call through an electronic device according to an embodiment of the disclosure.

FIG. 20 is a graph illustrating the levels of leaked sounds measured in a first state and a second state of an electronic device, respectively according to an embodiment of the disclosure.

The embodiments of FIGS. 19 to 20 may be combined with the embodiments of FIGS. 1 to 18.

Referring to FIG. 19, a state is shown in which a user positions the electronic device 101 (e.g., the electronic device 101 of FIG. 1 or the electronic device 101 of FIGS. 2 to 16) adjacent to a body part such as the user's face or ear e for a call. The first opening (e.g., the first opening 402 of FIGS. 6A and 6B) of the electronic device 101 may be disposed to face the user's ear e. The second opening (e.g., the second opening 404 of FIGS. 6A and 6B) of the electronic device 101 may face a direction different from the first opening. When the user makes a call, a first sound generated from the first surface (e.g., the diaphragm 520 of FIGS. 6A and 6B) of the diaphragm may be output to the user's ear e through the first opening. A second sound generated from the second surface of the diaphragm may be output through the second opening into a space P located to a side of the user's face. In this case, as the first sound and the second sound have phases opposite to each other, they may cancel each other out in the space P. Accordingly, as the leakage of the user's call audio to the outside is restricted and/or reduced, the user's privacy may be protected.

Referring to FIG. 20, when the electronic device is mounted on a head and torso simulator (HATS), the graph shows sound pressure levels (SPLs) (e.g., decibels (dB)) measured in the space P described with reference to FIG. 19 in the first state and the second state. The first state represents, for example, a state in which at least one first door (e.g., the first door 440 of FIG. 6A) closes a second sound path (e.g., the second sound path 434 of FIG. 6A). The second state represents, for example, a state in which the at least one first door opens the second sound path. It may be identified that as the first sound and the second sound undergo destructive interference with each other in the space P, the level of a sound measured in the second state decreases by about 20 dB compared to a sound magnitude measured in the first state in a main voice frequency band (e.g., a frequency of 1000 hertz (Hz) or less). Accordingly, in the second state, a sound output from the electronic device 101 does not leak into the space P, thereby enhancing the protection of the user's personal information.

An electronic device may include a speaker module including a diaphragm, a magnet, or a voice coil. The speaker module may be configured to output a sound through a hole (e.g., a receiver hole for a call) formed in a housing of the electronic device.

The receiver hole for a call may be located adjacent to an edge of a display. Since the receiver hole for a call is positioned adjacent to the edge of the display or a corner of the housing, a sound output from the receiver hole may propagate in a direction other than a user's ear. Consequently, the contents of the user's call may be leaked to the outside, making the user's personal information protection vulnerable.

According to an embodiment of the disclosure, a speaker and an electronic device including the same may be provided, which may restrict and/or reduce external leakage sound, when a user makes a call through the electronic device.

However, the problems to be solved by the disclosure are not limited to the above-mentioned problems and may be variously determined within a scope that does not depart from the spirit and scope of the disclosure.

According to an embodiment of the disclosure, an electronic device may be provided, which enhances the protection of a user's personal information by restricting and/or reducing external leakage sound when a user makes a call through the electronic device.

The effects obtainable from the disclosure are not limited to those mentioned above, and other effects not mentioned will be clearly understood by those skilled in the art from the following description.

According to an embodiment of the disclosure, the electronic device 101 may include the housing 401, the speaker 500, the first sound path 432, or the second sound path 434. The housing 401 may include the first opening 402 or the second opening 404. The second opening 404 may face in a direction different from a direction in which the first opening 402 faces. The speaker 500 may be disposed in the housing 401. The speaker 500 may include the diaphragm 520. A first sound generated by vibration of the diaphragm 520 may be output through the first sound path 432 extending from the first surface of the diaphragm 520 to the first opening 402, and a second sound generated by the vibration of the diaphragm may be output through the second sound path 434 extending from another surface of the diaphragm 520 to the second opening 404. A phase of the first sound may be substantially opposite to a phase of the second sound.

According to an embodiment, the first sound path 432 may be associated with one side (e.g., the first surface) of the diaphragm 520 and the first opening 402. The second sound path 434 may be associated with the other side (e.g., a surface different from the first surface) of the diaphragm 520 and the second opening 404. The electronic device 101 may be configured such that when the diaphragm 502 is vibrated and the second sound path 434 is opened, the first sound output through the first opening 402 may be attenuated by the second sound output through the second opening 404.

According to an embodiment, the electronic device 101 may further include the at least one door 440 or 640 positioned in at least one of the first sound path 432 or the second sound path 434.

According to an embodiment, the electronic device 101 may further include the at least one processor 120 or the memory 130. The at least one processor 120 may include processing circuitry. The memory 130 may store instructions. The instructions, when executed by the at least one processor 120 individually or collectively, may cause the electronic device to control the at least one door 440 or 640 to be opened and/or closed based on execution of an application associated with the first sound.

According to an embodiment, the instructions, when executed by the at least one processor 120 individually or collectively, may cause the electronic device to identify whether the application associated with the first sound is a voice call application, and control the at least one door 440 or 640 to be opened such that the first sound is output through the first opening 402 and the second sound is output through the second opening 404 based on identification that the application associated with the first sound is the voice call application.

According to an embodiment, the instructions, when executed by the at least one processor 120 individually or collectively, may cause the electronic device to identify whether the application associated with the first sound is the voice call application, and control the at least one door 440 or 640 to be closed such that one of the first sound through the first opening 402 or the second sound through the second opening 404 is not output based on identification that the application associated with the first sound is an application other than the voice call application.

According to an embodiment, the electronic device 101 may further include the display 420. The display 420 may be disposed on the housing 401. The first opening 402 adjacent to an upper edge of the display 420 may be formed on the front surface of the electronic device. The second opening 404 may be formed on another surface of the electronic device. The first opening 402 may be adjacent to the second opening 404 such that the first sound is attenuated by the second sound.

According to an embodiment, the other surface of the electronic device may be a side surface of the electronic device.

According to an embodiment, the electronic device may further include another speaker 600. The other speaker 600 may be disposed in the housing 401. The speaker 600 may be spaced apart from the speaker 500. The speaker 500 may be a receiver-type speaker, and the other speaker 600 may be a multimedia-type speaker.

According to an embodiment, the speaker 500 may further include the case 510 or the mesh 511. The mesh 511 may be formed on the case 510. The second sound may be configured to be output through the mesh 511, the second sound path 434, and the second opening 404. That is, an audio path may be in order through the mesh 511, the second sound path 434, and the second opening 404.

According to an embodiment, the electronic device may further include the at least one door 440. The at least one door 440 may be disposed in the second sound path 434. At least a portion of the second sound path 434 may be configured to be opened or closed by the at least one door 440.

According to an embodiment, the electronic device may further include the waterproof member 480. The waterproof member 480 may be disposed in the second sound path 434.

According to an embodiment, the waterproof member 680 may be formed integrally with the at least one door 440.

According to an embodiment, the electronic device 101 may further include the first sound mesh 491 and the second sound mesh 492. The first sound mesh 491 may be disposed in the second sound path 434. The first sound mesh 491 may be disposed between the waterproof member 480 and the case 510. The second sound mesh 492 may be disposed in the second opening 404.

According to an embodiment, the electronic device 101 may further include the at least one door 640. The at least one door 640 may be disposed in the first sound path 432. At least a portion of the first sound path 432 may be configured to be opened or closed by the at least one door 640.

According to an embodiment, the speaker 500 may further include the cover housing 501. The cover housing 501 may include the resonance space 503.

According to an embodiment, the speaker 500 may further include the sound absorbing member 550. The sound absorbing member 550 may be accommodated in the resonance space 503.

According to an embodiment, the electronic device 101 may further include the third sound path 450. The third sound path 450 may extend from the first sound path 432 to the second sound path 434.

According to an embodiment, when the diaphragm 520 is vibrated, the first sound output from the one side of the diaphragm 520 may have a phase substantially opposite to the phase of the second sound output from the other side of the diaphragm 520.

According to an embodiment, the electronic device 101 may further include a plurality of second openings 404 or a plurality of second sound paths 434. The plurality of second sound paths 434 may be associated with the plurality of second openings 404, respectively.

According to an embodiment of the disclosure, the electronic device 101 may include the housing 401, the speaker 500, the first sound path 432, the second sound path 434, or the at least one first door 440. The housing 401 may include the first opening 402 or the second opening 404. The second opening 404 may face in a direction different from a direction in which the first opening 402 faces. The speaker 500 may be disposed in the housing 401. The speaker 500 may include the diaphragm 520. The first sound path 432 may be associated with one side of the diaphragm 520 and the first opening 402. The second sound path 434 may be associated with the other side of the diaphragm 520 and the second opening 404. The at least one door 440 may be disposed in the second sound path 434. The second sound path 434 may be configured to be opened or closed by the at least one door 440.

According to an embodiment, the electronic device 101 may further include the display 420. The display 420 may be disposed on the housing 401. The first opening 402 may be defined by the housing 401 and the display 420.

According to an embodiment, the speaker 500 may include the case 510, the diaphragm 520, the magnet 530, or the voice coil 540. The diaphragm 520 may be disposed on one surface of the case 510. The magnet 530 may be disposed within the case 510. The voice coil 540 may be disposed within the case 510.

According to an embodiment, the one side of the diaphragm 520 may be disposed to face the display 420. The other side of the diaphragm 520 may be disposed to face the magnet 530.

According to an embodiment, the housing 401 may include the sidewall 4104. The sidewall 4104 may form at least a portion of a side surface of the electronic device 101. The second opening 404 may be formed in the sidewall 4104.

According to an embodiment of the disclosure, the electronic device 101 may include the housing 401, the speaker 500, the first sound path 432, the second sound path 434, or the at least one door 440 or 640. The housing 401 may include the first opening 402 or the second opening 404. The second opening 404 may face a direction different from a direction in which the first opening 402 faces. The speaker 500 may be disposed in the housing 401. The speaker 500 may include the diaphragm 520. The first sound path 432 may be associated with one side of the diaphragm 520 and the first opening 402. The second sound path 434 may be associated with the other side of the diaphragm 520 and the second opening 404. The at least one door 440 or 640 may be disposed in at least one of the first sound path 432 or the second sound path 434.

According to an embodiment of the disclosure, the electronic device 101 may include the housing 401, the speaker 500, the first sound path 432, the second sound path 434, the at least one door 440, the at least one processor 120, or the memory 130. The housing 401 may include the first opening 402 or the second opening 404. The second opening 404 may face a direction different from a direction in which the first opening 402 faces. The speaker 500 may be disposed in the housing 401. The speaker 500 may include the diaphragm 520. The first sound path 432 may be associated with one side of the diaphragm 520 and the first opening 402. The second sound path 434 may be associated with the other side of the diaphragm 520 and the second opening 404. The at least one door 440 may be disposed in the second sound path 434. The at least one processor 120 may include processing circuitry. The memory 130 may store at least one instruction. The at least one instruction, when executed individually or collectively by the at least one processor 120, may cause the electronic device 101 to perform at least one operation. The at least one operation may include identifying an output of the speaker 500. The at least one operation may include identifying whether the electronic device 101 is in a call mode based on a state in which the speaker 500 is outputting. The at least one operation may include controlling the at least one door 440 such that the second sound path 434 is opened, based on the electronic device 101 being in the call mode.

According to an embodiment, the at least one operation may further include controlling the at least one door 440 such that the second sound path 434 is closed, based on the electronic device 101 being in a non-call mode.

According to an embodiment, the at least one operation may further include identifying whether an intensity of a first sound output through the first opening 402 is greater than or equal to a first value. The at least one operation may further include controlling the at least one door 440 such that the second sound path 434 is opened, based on the intensity of the first sound being greater than or equal to the first value.

According to an embodiment, the at least one operation may further include controlling the at least one door 440 such that the second sound path 434 is partially opened, based on the intensity of the first sound being less than the first value.

While specific embodiments have been described in the detailed description of the disclosure, it will be apparent to those skilled in the art that various modifications may be made without departing from the scope of the disclosure.

What is claimed is:

1. An electronic device comprising:
a housing including a first opening, and a second opening facing in a direction different from a direction in which the first opening faces; and
a speaker disposed in the housing and including a diaphragm,
wherein when the diaphragm is vibrated, a first sound generated by vibration of the diaphragm is output through a first sound path extending from the diaphragm to the first opening, and a second sound generated by the vibration of the diaphragm is output through a second sound path extending from the diaphragm to the second opening, and
wherein a phase of the first sound is substantially opposite to a phase of the second sound.

2. The electronic device of claim 1, further comprising at least one door positioned in at least one of the first sound path and the second sound path.

3. The electronic device of claim 2, further comprising:
at least one processor including processing circuitry; and
memory which stores instructions,
wherein the instructions, when executed by the at least one processor individually or collectively, cause the electronic device to control the at least one door to be opened and/or closed based on execution of an application associated with the first sound.

4. The electronic device of claim 3, wherein the instructions, when executed by the at least one processor individually or collectively, cause the electronic device to:
identify whether the application associated with the first sound is a voice call application; and
control the at least one door to be opened such that the first sound is output through the first opening and the second sound is output through the second opening based on identification that the application associated with the first sound is the voice call application.

5. The electronic device of claim 3, wherein the instructions, when executed by the at least one processor individually or collectively, cause the electronic device to:
identify whether the application associated with the first sound is the voice call application; and
control the at least one door to be closed such that one of the first sound through the first opening or the second sound through the second opening is not output based on identification that the application associated with the first sound is an application other than the voice call application.

6. The electronic device of claim 1, further comprising a display disposed on the housing,
wherein the first opening is adjacent to an upper edge of the display and is formed on a front surface of the electronic device, and the second opening is formed on another surface of the electronic device, and
wherein the first opening is adjacent to the second opening such that the first sound is attenuated by the second sound.

7. The electronic device of claim 6, wherein the another surface of the electronic device is a side surface of the electronic device.

8. The electronic device of claim 1, further comprising another speaker disposed in the housing and spaced apart from the speaker,
wherein the speaker is a receiver-type speaker, and the other speaker is a multimedia-type speaker.

9. The electronic device of claim 1, wherein the speaker further includes a case and a mesh which is formed on the case, and
wherein the second sound is configured to be output through the mesh, the second sound path, and the second opening.

10. The electronic device of claim 1, further comprising a waterproof member disposed in the second sound path.

11. The electronic device of claim 10, wherein the waterproof member is formed integrally with the at least one door.

12. The electronic device of claim 1, further comprising:
a first sound mesh disposed in the second sound path; and
a second sound mesh disposed in the second opening.

13. The electronic device of claim 1, wherein the speaker further includes a cover housing including a resonance space.

14. The electronic device of claim 13, wherein the speaker further includes a sound absorbing member accommodated in the resonance space.

15. The electronic device of claim 1, further comprising a third sound path extending from the first sound path to the second sound path.

16. An electronic device comprising:
a housing including a first external opening and a second external opening which faces in a direction different from a direction in which the first external opening faces; and
a speaker disposed in the housing and configured to output a first sound and a second sound in opposite phases to each other,
wherein when the speaker outputs sounds, the first sound is output through a first sound path extending from the speaker to the first external opening, and the second sound is output through a second sound path extending from the speaker to the second external opening, and
wherein an amount of at least one of the first sound and the second sound which is incident to the first external opening and the second external opening is changeable within the first sound path and the second sound path, respectively.

17. The electronic device of claim 16, further comprising:
at least one door positioned in at least one of the first sound path and the second sound path.
at least one processor including processing circuitry; and
memory which stores instructions,
wherein the instructions, when executed by the at least one processor individually or collectively, cause the electronic device to control the at least one door based on execution of an application associated with the first sound.

18. The electronic device of claim 17, wherein when the application associated with the first sound is a voice call application, the instructions, when executed by the at least one processor individually or collectively, cause the electronic device to at least partially open the at least one door and maintain at least a portion of the amount of the at least one of the first sound and the second sound to be incident to a respective external opening.

19. The electronic device of claim 17, wherein when the application associated with the first sound is an application other than a voice call application, the instructions, when executed by the at least one processor individually or collectively, cause the electronic device to close the at least one door and reduce the amount of the at least one of the first sound and the second sound.

20. The electronic device of claim 16, further comprising a display disposed on the housing, at a front surface of the electronic device,
wherein the first external opening is disposed adjacent to an edge of the display, and
wherein the second external opening is disposed adjacent to the first external opening.
